(19) United States
(12) Patent Application Publication
(10) Pub. No.: US 2021/0174694 A1
(43) Pub. Date: Jun. 10, 2021

(54) DEVICE FOR PROVIDING PROBLEM-SOLVING BASED LEARNING SERVICE AND METHOD THEREFOR

(71) Applicant: SCAPEFLOW, INC., New York, NY (US)

(72) Inventor: Mookwang JOUNG, New York, NY (US)

(21) Appl. No.: 16/761,168

(22) PCT Filed: Nov. 1, 2018
(86) PCT No.: PCT/KR2018/013171

§ 371 Date: May 1, 2020

(30) Foreign Application Priority Data
Nov. 3, 2017 (KR) 10-2017-0146046

(51) Int. Cl. G09B 7/12; G09B 5/10; G09B 7/073; G06Q 30/02; G06Q 50/20

(52) U.S. Cl. CPC G09B 7/12; G09B 5/10; G06Q 50/20; G06Q 30/0251; G09B 7/073

(57) ABSTRACT

A method for providing a learning service includes the stages of: constructing information on a learning path connecting one or more learning objectives; providing a learner's terminal with a problem-solving service corresponding to a first learning objective on the learning path; and according to the result of problem solving by the learner, determining whether to provide a learning content corresponding to the first learning objective.

### TECHNICAL FIELD

The present invention relates to an apparatus and method for providing a learning service and, more particularly, to an apparatus and method for providing a learning service based on problem solving using a learning path.

### BACKGROUND ART

With the recent development of the Internet technology, an online education method of enabling learners, that is, educates, to perform learning even at homes using the Internet without moving to a given education place has been in the spotlight. The online education method has an advantage in that a class can be taken without time and space constraints, but has a limit in performing an education progress suitable for the capability of a learner because the online education method is aimed at multiple learners.

In particular, although the follow-up learning of learning contents is understood only when the full understanding of the most basic concept contents is supported, such online education has a problem in that learning continuously proceeds to a next stage without accurately checking how degree of knowledge does a learner have. Through such an online education method, accurate evaluation based on a level of a learner is difficult, a learner loses interest in learning when a given stage is exceeded, and distrust and dissatisfaction over learning itself are increased because a learning effect itself disappears.

Furthermore, in a current education system, the reason why a learner does not learn knowledge of a next stage because the learner does not understand which concept is not accurately determined, but instead only evaluation and re-learning in a comprehensive level are simply performed.

### DISCLOSURE

### Technical Problem

The present invention has been proposed to solve such a problem, and an object of the present invention is to provide an apparatus and method for providing a learning service, wherein problem solving according to a learning path between learning objectives formed stage by stage is provided, learning content for a substantially necessary concept for each learner is confirmed based on a result of the problem solving and properly provided to the learner, and the learner learns concepts at next stages after the learning of the learning content is confirmed, so the learner can have a sense of accomplishment and a motivation to study for each stage because the learner can find an actually necessary learning stage and perform learning and an educator can clearly evaluate the learning ability and level of the learner.

### Technical Solution

A method according to an embodiment of the present invention for solving the above object is a method of providing a learning service, including the steps of constructing learning path information connecting one or more learning objectives, providing a terminal of a learner with a problem solving service corresponding to a first learning objective of the learning path, and determining whether to provide learning content corresponding to the first learning objective based on a result of the problem solving of the learner.

An apparatus according to an embodiment of the present invention for solving the above object is an apparatus for providing a learning service, including a learning information management unit constructing learning path information connecting one or more learning objectives, a problem information management unit providing a terminal of a learner with a problem solving service corresponding to a first learning objective of the learning path, and a service provision unit determining whether to provide learning content corresponding to the first learning objective based on a result of the problem solving of the learner.

Meanwhile, a computer-readable recording medium in which a program for executing the method according to an embodiment of the present invention in a computer has been written may be implemented.

### Advantageous Effects

According to an embodiment of the present invention, there are provided the apparatus and method for providing a learning service, wherein problem solving according to a learning path between learning objectives formed stage by stage is provided, learning content for a substantially necessary concept for each learner is confirmed based on a result of the problem solving and properly provided to the learner, and the learner learns concepts at next stages after the learning of the learning content is confirmed so that the learner can have a sense of accomplishment and a motivation to study for each stage because the learner can find an actually necessary learning stage and perform learning and an educator can clearly evaluate the learning ability and level of the learner, in such a manner that a problem solving service corresponding to a first learning objective of the learning path is provided to the terminal of the learner through the problem information management unit and whether to provide learning content corresponding to the first learning objective is determined based on a result of the problem solving of the learner.

### DESCRIPTION OF DRAWINGS

FIG. 1 is a diagram schematically illustrating a general system according to an embodiment of the present invention.

FIG. 2 is a block diagram more specifically describing a learning service provision apparatus according to an embodiment of the present invention.

FIGS. 3 to 5 are flowcharts for describing methods of providing a learning service according to embodiments of the present invention.

FIGS. 6 to 8 are diagrams for describing graphic interfaces for a learning service according to embodiments of the present invention.

### MODE FOR INVENTION

The following contents illustrate only the principle of the present invention. Although various apparatuses have not been clearly described or illustrated in this specification, those skilled in the art may implement the apparatuses that implement the principle of the present invention and are included in the concept and scope of the present invention. Furthermore, it should be understood that in principle, conditional terms and embodiments listed in this specification are evidently intended only in order for the concept of the present invention to be understood and the scope of rights of the present invention is not restricted by the specially listed embodiments and states.

Furthermore, it should be understood that all the detailed descriptions that list given embodiments in addition to the principle, aspects, and embodiments of the present invention are intended to include the structural and functional equivalents of such matters. Furthermore, it should be understood that the equivalents include equivalents to be developed in the future, that is, all devices invented to perform the same function by substituting some elements, in addition to known equivalents.

Accordingly, it should be understood that a block diagram of this specification, for example, is indicative of a conceptual viewpoint of an exemplary circuit that materializes the principle of the present invention. Likewise, it should be understood that all flowcharts, state change diagrams, and pseudo code may be substantially represented in computer-readable media and are indicative of various processes that are executed by computers or processors regardless of whether the computers or processors are evidently illustrated.

The functions of processors or the functions of various devices illustrated in the drawings that include function blocks illustrated as a similar concept may be provided by the use of hardware capable of executing software in relation to proper software, in addition to dedicated hardware. When being provided by a processor, the function may be provided by a single dedicated processor, a single sharing processor, or a plurality of processors, and some of them may be shared.

Furthermore, a processor, control, or a term suggested as a similar concept thereof, although it is clearly used, should not be construed as exclusively citing hardware having the ability to execute software, but should be construed as implicitly including digital signal processor (DSP) hardware, or ROM, RAM, or non-volatile memory for storing software without restriction. The processor, control, or term may also include known other hardware.

In the claims of this specification, an element represented as means for executing a function written in a detailed description has been intended to include all methods of performing a function including all types of software which include a combination of circuit elements configured to perform the function or firmware/microcode, and is combined with a proper circuit configured to execute the software in order to perform the function. It is to be understood that any means capable of providing the function is equivalent with a thing checked from this specification because functions provided by variously listed means are combined and the present invention defined by the claims is combined with a method required by the claims.

The above objects, characteristics, and merits will become more apparent from the following detailed description taken in conjunction with the accompanying drawings, and thus those skilled in the art to which the present invention pertains may readily implement the technical spirit of the present invention. Furthermore, in describing the present invention, a detailed description of a known art related to the present invention will be omitted if it is deemed to make the gist of the present invention unnecessarily vague.

Preferred embodiments in accordance with the present invention are described in detail below with reference to the accompanying drawings.

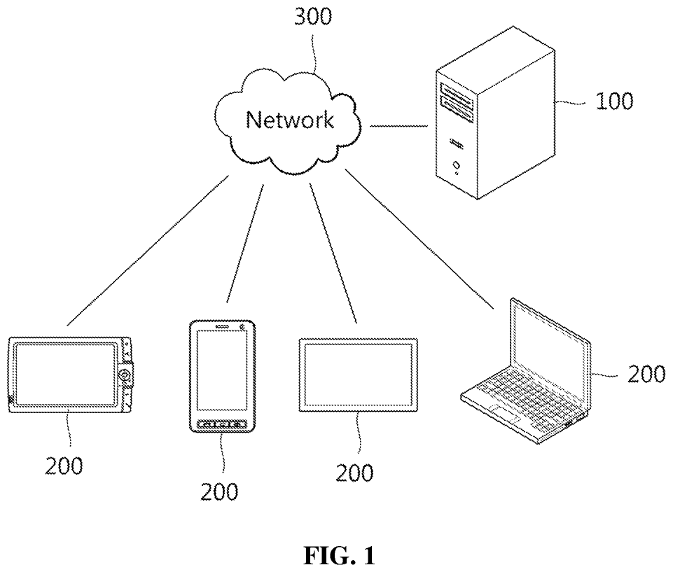

FIG. 1 is a diagram schematically illustrating a general system according to an embodiment of the present invention.

Referring to FIG. 1, a general system for the provision of a learning service based on a learning path according to an embodiment of the present invention includes a learning service provision apparatus 100, at least one terminal 200 and a network 300.

First, the at least one terminal 200 may be one or plural in number. Different terminals 200 may be connected to the learning service provision apparatus 100 over the network 300, and may perform mutual communication.

In this case, communication provided by the network 300 may be implemented using all types of wired/wireless networks, such as a local area network (LAN), a wide area network (WAN), a value added network (VAN), a personal area network (PAN), a mobile radio communication network or a satellite communication network. For example, a network over which mutual communication can be performed may be provided using a communication method, such as a mobile communication network, universal plug and play (UPnP), or WiFi.

Furthermore, the one or more terminals 200 may be a stationary terminal or a portable and mobile terminal. The one or more terminals 200 may be, for example, a navigator, a smartphone, a mobile phone, a computer, a laptop computer, a terminal for digital broadcasting, a personal digital assistants (PDA), a portable multimedia player (PMP), a mobile Internet apparatus (MID), and a tablet PC.

Furthermore, any one terminal 200 may configure communication with other terminals 200 over the network 300 through the learning service provision apparatus 100. Furthermore, the terminals 200 connected to the network 300 may cooperatively share various types of content including learning content.

To this end, the learning service provision apparatus 100 may relay communication between network service provision servers. Furthermore, the learning service provision apparatus 100 may perform remote or direct control so that a learning service according to an embodiment of the present invention is provided through each of the terminals 200.

Accordingly, each of the one or more terminals 200 accesses the learning service provision apparatus 100 over the network 300. The learning service provision apparatus 100 may provide a learning service by processing information related to a state within a learning section of each terminal 200. Furthermore, the learning service provision apparatus 100 may share information related to various types of learning or transmit a message while operating in conjunction with an online communication service.

Accordingly, referring to FIG. 1, the learning service provision apparatus 100 may access the World Wide Web over the network 300, and may construct learning information and a database for the provision of learning information and a learning service.

Furthermore, the learning service provision apparatus 100 may collect learning information corresponding to a learning path based on a learning objective or lesson plan using a constructed database, may process relation information based on the collected learning information, and may perform hierarchical processing.

Furthermore, the learning service provision apparatus 100 may form one or more learning paths by connecting a learning item corresponding to a specific learning objective and points thereof stage by stage. Accordingly, the learning path may include connection information and sequence information between learning points at which learning content for each learning item is provided or problem solving is provided.

In this case, the learning path may include path information which is previously determined by an expert in the field of learning items or generated or updated in response to a user input based on a pre-determined specific sequence.

Furthermore, the learning path may be formed based on a given degree of temporal or logical priority, and may be updated in a cooperative and self-regulation method based on interaction accumulation data between a use and an item. Accordingly, the user can learn new knowledge or current knowledge of the user can be evaluated by performing search based on a learning path. For example, a user may have his or her skill level evaluated by watching an image, reading a web page or performing problem solving in learning content provided at a specific point in a learning path.

Meanwhile, the learning path may be formed in a visual knowledge map which is related to knowledge information collected by the learning service provision apparatus 100 and which may be explored and visually recognized in the terminal 200 of a user based on hierarchically processed learning information.

For example, the visual knowledge map may include a two-dimensional or a three-dimensional map. Coordinates may correspond to the coordinates of the aforementioned learning item. The distance between the coordinates of learning items and the locations of the learning items may be determined based on relation information and hierarchical processing information. Accordingly, the visual knowledge map based on knowledge information of the World Wide Web can be constructed in various ways.

For example, the learning service provision apparatus 100 may construct a visual knowledge map that is visualized and searched for by performing a given computerized instruction for a dimension reduction method of maintaining distance information to a maximum extent through a controller 110 and performing a reduction to one, two or three spatial dimensions. Results including a set of calculated coordinates of concepts in one, two or three-dimensional finite space may be stored in at least one database.

Furthermore, the learning service provision apparatus 100 may convert coordinates or points into areas, such as a polygon, in order to construct a visual knowledge map. For example, the learning service provision apparatus 100 may process the coordinates or points using a plane/space segmentation (tessellation) method, such as Voronoi tiling. In this case, the coordinates of the vertexes of each polygon may be stored in at least one database.

A learning path according to an embodiment of the present invention may be constructed in a visual knowledge map, such as that described above. Accordingly, the visual knowledge map may include each learning item group. The item groups may be connected through the sequence of directed weighted edges including a plurality of weights having a form, such as a line or an arrow, based on relation information, thus forming a linear sequence, a loop (closed circuit), a tree or a graph.

Furthermore, according to an embodiment of the present invention, the learning service provision apparatus 100 may provide a learning service based on a learning path to the terminal 200 of a user that has accessed the learning service provision apparatus 100.

To this end, the learning service provision apparatus 100 may provide learning content based on a learning path corresponding to a today's learning objective in accordance with a service target user. Furthermore, the learning service provision apparatus 100 can significantly improve a learning effect by providing repeated learning and concept understanding based on problem solving corresponding to the learning path and the learning content.

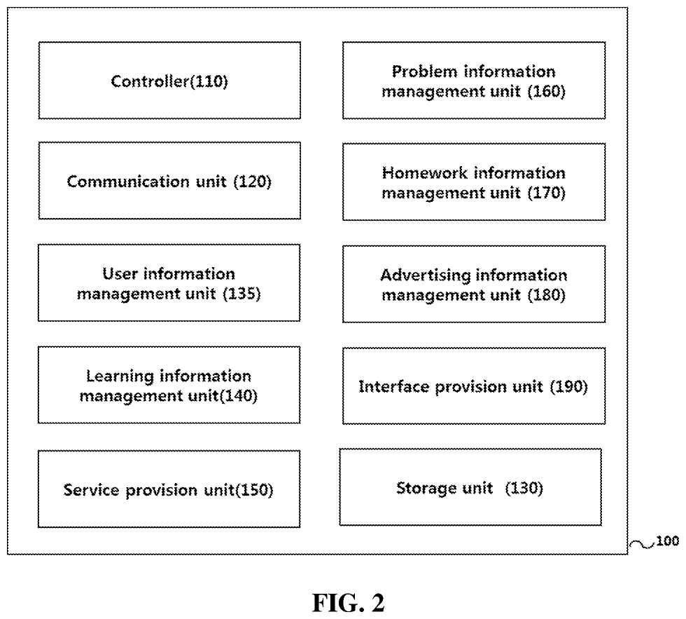

FIG. 2 is a block diagram more specifically describing a learning service provision apparatus according to an embodiment of the present invention.

Referring to FIG. 2, the learning service provision apparatus 100 according to an embodiment of the present invention may include a controller 110, a communication unit 120, a storage unit 130, a user information management unit 135, a learning information management unit 140, a service provision unit 150, a problem information management unit 160, a homework information management unit 170, an advertising information management unit 180, and an interface provision unit 190.

The controller 110 commonly controls an overall operation of the learning service provision apparatus 100. For example, the controller 110 performs overall communication control and data processing between related modules for various types of information processing, such as learning information collection, user information management, relation information generation, hierarchical processing, learning path generation, learning information management, interface provision and management, data communication, message transmission, and SNS access. In FIG. 2, for control between the elements, the controller 110 has been illustrated as being separately present. Although the controller 110 is not included, some of or all functions of the controller 110 may be distributed to elements, synchronized and operated.

The communication unit 120 may be connected to the terminal 200 over the network 300, and may perform the data transmission and reception of learning service information to and from the terminals 200. The wireless communication unit 110 may include one or more modules which enables wireless communication between the terminal 200 and the server 100 or between the terminal 200 and the network 300 in which the terminal 200 is located. For example, the communication unit 120 may include a mobile communication module, a wired Internet module, a wireless Internet module, and a short range communication module.

For example, the mobile communication module transmits and receives radio signals to and from at least one of a base station, an external terminal, and a server over a mobile communication network. The radio signal may include various forms of data according to the transmission and reception of a voice call signal, a video call signal or a text/multimedia message. Furthermore, the wireless Internet module refers to a module for wireless Internet access, and may be embedded in the terminal 200 or positioned outside the terminal 200. A wireless LAN (WLAN) (Wi-Fi), a wireless broadband (Wibro), world interoperability for microwave access (Wimax), or high speed downlink packet access (HSDPA) may be used as a wireless Internet technology. The short range communication module may mean a module for short range communication. Bluetooth, radio frequency identification (RFID), infrared communication (infrared data association (IrDA), a ultra wideband (UWB), or ZigBee may be used as a short range communication technology.

The user information management unit 135 may register and manage user information in accordance with learning service users according to an embodiment of the present invention. The user information may include personal information of a user. In relation to a user, pieces of identification information corresponding to a teacher and a learner, respectively, may be set. Relation information between users may be set. The user information may be newly registered, updated and managed in response to a user information registration or update request received from the terminal 200. Furthermore, some of or the entire user information may be transmitted to the terminal 200 in response to a request from the terminal 200.

The user information management unit 135 may classify and manage user information for each learner and teacher. The user information may include at least one of birth date, sex, name, mobile phone number, address, and profile information of a learner, for example, and may include learning objective information corresponding to the learner and skill level information corresponding to a learning objective. Furthermore, the user information may include at least one of birth date, sex, name, mobile phone number, address, or profile information of a teacher, for example, and may include learner directory information corresponding to the teacher.

The storage unit 130 may store, in a previously designated storage space, control data for an operation of the controller 110, and user information, collection information, relation information, knowledge information, learning path information, problem solving information, and other information manage in each of the elements, character information, and game information for interface provision.

In particular, according to an embodiment of the present invention, the storage unit 130 may include problem information, a learning objective, a learning path, and learning item information in accordance with a user previously registered with user information, and may include the learning path and a learning information data region corresponding to learning item information. Learning history information including information on a degree of achievement that has been obtained by a user with respect to a problem solving service challenged by the user in a learning path may be stored in the learning information data region.

Meanwhile, the learning information management unit 140 may provide learning content to the terminal 200 of a learner through the service provision unit 150 according to a learning path.

Meanwhile, the learning path generation unit 160 may form a learning path that connects learning items stage by stage in achieving a learning objective. In this case, the learning path may include points for learning one or more learning items. A user may move to points in each stage according to a sequence through a menu interface provided by the learning service provision apparatus 100.

In particular, according to an embodiment of the present invention, the learning path generation unit 160 may include path information which is previously determined by an expert in the field of a lesson or learning item or generated or updated in response to a user input according to a pre-determined specific sequence.

Furthermore, the service provision unit 150 may provide a problem solving service in accordance with the provision of learning content. To this end, problem information corresponding to learning information generated by the learning information management unit 140 may be generated and stored in the problem information management unit 160.

Meanwhile, the homework information management unit 170 may allocate homework information based on a response result of a problem solving service provided to a learner, and may provide the allocated homework information to the terminal 200.

Furthermore, the advertising information management unit 180 may set advertising information for each learning path, which is stored and managed in the learning information management unit 140. The advertising information may be provided together when the learning information management unit 140 provides learning content or a problem solving service, and may be exposed to the user of the terminal 200. Accordingly, the advertising information management unit 180 may compute advertising cost information based on association between use frequency information corresponding to the section of a learning path and a learning objective corresponding to advertising information. Accordingly, there are advantages in that advertisers can arrange proper advertising expenses and a learner can be provided with more related learning advertising.

Meanwhile, the interface provision unit 190 may generate various graphic user interfaces (GUIs) for providing learning content, providing an interface for a problem solving service, checking a dashboard, and using and indexing a learning service, and may provide the GUIs to the terminal 200 of a user that has accessed the learning service provision apparatus.

The interface provision unit 190 may transmit an interface to the terminal 200 over a wired/wireless network using a communication method through the communication unit 120. The interface may be implemented as a graphic object of a form which may be played back in the terminal 200, and may be displayed in various ways in response to a user input.

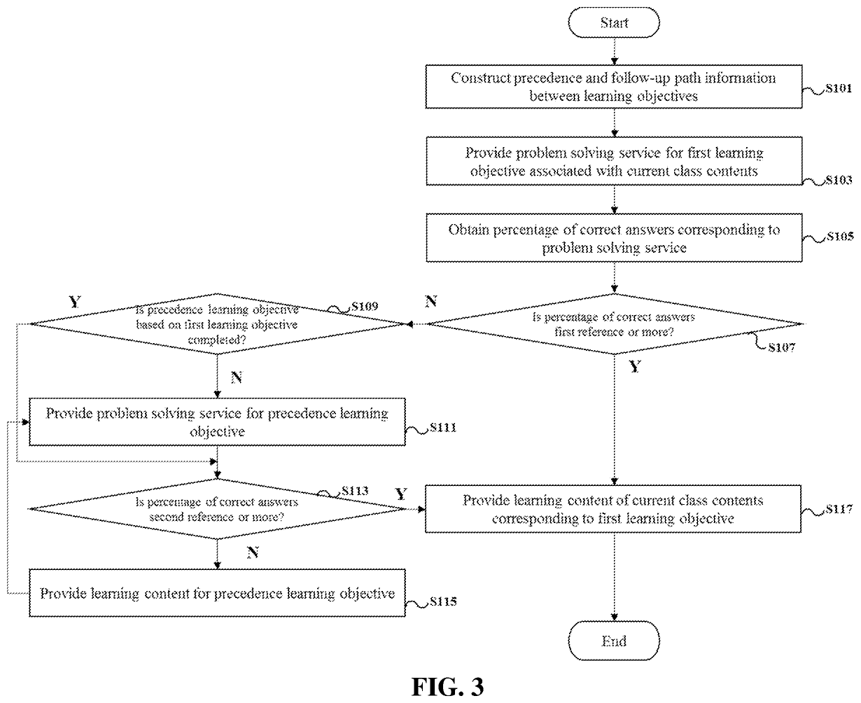

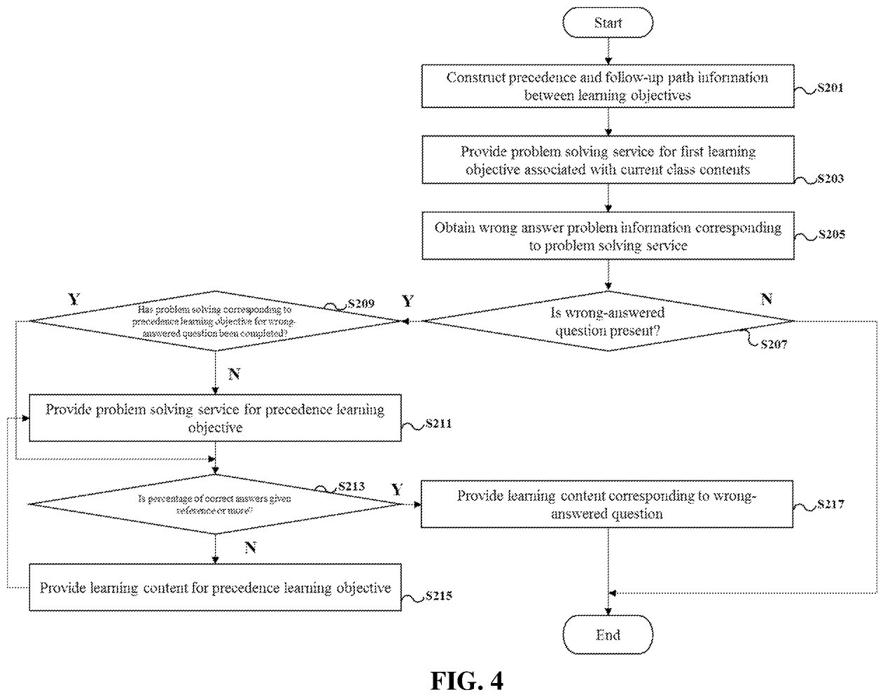

FIGS. 3 and 4 are flowcharts for describing a method of providing a learning service according to an embodiment of the present invention.

Referring to FIG. 3, first, the learning service provision apparatus 100 constructs a learning path including information on precedence and follow-up paths between learning objectives (S101).

Furthermore, the learning service provision apparatus 100 provides the terminal 200 with a problem solving service for a first learning objective associated with current class contents (S103).

Furthermore, the learning service provision apparatus 100 obtains information on a percentage of correct answers corresponding to the problem solving service (S105).

In this case, when the percentage of correct answers is a first reference or more (S107), the learning service provision apparatus 100 may provide the terminal 200 with learning content of the current class contents corresponding to the first learning objective (S117).

In contrast, when the percentage of correct answers is less than the first reference, the learning service provision apparatus 100 determines whether to complete a precedence learning objective in the learning path based on the first learning objective (S109).

In this case, the precedence learning objective may be plural. The plurality of precedence learning objectives may be classified into a completed precedence learning objective and a not-completed precedence learning objective. Any one of the not-completed precedence learning objectives may be selected.

Accordingly, if a not-completed precedence learning objective is present, the service provision apparatus 100 provides a problem solving service for the corresponding precedence learning objective (S111).

Thereafter, the service provision apparatus 100 confirms a result of the problem solving service for the precedence learning objective, and compares a percentage of correct answers for the precedence learning objective with a second reference value (S113). When the percentage of correct answers is the second reference or more, the service provision apparatus 100 enters step S117 and provides learning content.

In contrast, when the percentage of correct answers is less than the second reference, the service provision apparatus 100 provides the terminal 200 with learning content corresponding to the precedence learning objective (S115), and repeatedly determines whether to provide a problem solving service corresponding to the same or different precedence learning objective and content based on a determination of a percentage of correct answers. Accordingly, after mastering the precedence learning objective, a learner can learn the first learning objective stage by stage. In particular, if a plurality of precedence learning objectives is present, if learning items for a specific first precedence learning objective have been mastered, the service provision apparatus 100 may move to a learning point corresponding to another second precedence learning objective, and may provide learning content for the second precedence learning objective.

Meanwhile, the learning content corresponding to the precedence learning objective may further include homework information. For example, learning content may further include homework for raising a degree of understanding of precedence learning. Accordingly, a learner can understand a concept more clearly and easily perform learning in parallel to homework.

Furthermore, according to one embodiment of the present invention, a learning leader, such as a teacher, may allow a plurality of students who use the terminals 200, respectively, to solve problems related to a specific learning objective through the service provision apparatus 100 in class. The service provision apparatus 100 may generate homework information so that homework suitable for a level of learning of each student is assigned to the student based on a result of the problem solving. Furthermore, the service provision apparatus 100 may provide the terminal 200 of each learner with homework information for each learner based on a result of problem solving in response to an input or request from a learning leader.

To this end, a plurality of the learner terminals 200 may be provided. The specific first learning objective may be designated by a learning leader terminal (not illustrated) corresponding to the plurality of learner terminals 200. Furthermore, the service provision unit 150 may generate and provide homework information, corresponding to the first learning objective, based on a result of the problem solving of the learner. Accordingly, homework information for each learner based on the result of the problem solving is individually provided to each of the leader terminals 200 of the learners 200.

Meanwhile, referring to FIG. 4, first, the learning service provision apparatus 100 constructs a learning path including information on precedence and follow-up paths between learning objectives (S201).

Furthermore, the learning service provision apparatus 100 provides the terminal 200 with a problem solving service for a first learning objective associated with current class contents (S203).

Furthermore, the learning service provision apparatus 100 obtains wrong answer problem information corresponding to the problem solving service (S205).

In this case, when a wrong-answered question occurs (S207), the learning service provision apparatus 100 may confirm whether problem solving corresponding to a precedence learning objective for the wrong-answered question has been completed (S209). Furthermore, when a not-completed precedence learning objective is present, the learning service provision apparatus 100 provides a problem solving service corresponding to the precedence learning objective (S211).

Meanwhile, when the problem solving is completed, the service provision apparatus 100 determines whether a percentage of correct answers are a given reference or more. When the percentage of correct answers is the given reference or more, the service provision apparatus 100 provides learning content corresponding to a wrong-answered question (S217) in order to raise a degree of understanding of a wrong answer.

Meanwhile, when the percentage of correct answers is less than the given reference, the service provision apparatus 100 provides the terminal 200 with the learning content corresponding to the precedence learning objective again (S215), and repeatedly determines whether to provide a problem solving service, corresponding to the same or different precedence learning objective, and content based on a determination of a percentage of correct answers. Accordingly, after mastering a precedence learning objective, a learner can learn learning content corresponding to a wrong-answered question stage by stage. In particular, if a plurality of precedence learning objectives is present, if learning items for a specific first precedence learning objective have been mastered, the service provision apparatus 100 may move to a learning point corresponding to another second precedence learning objective, and may provide a problem solving service for the second precedence learning objective.

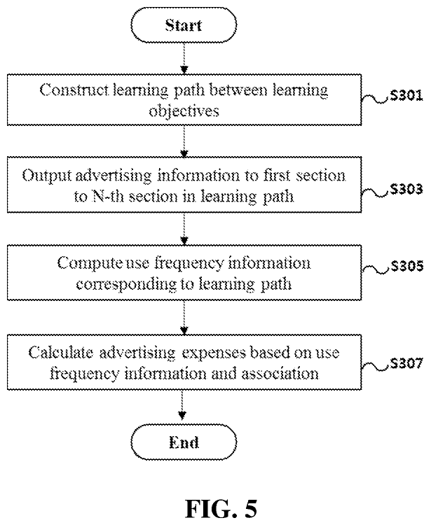

Meanwhile, FIG. 5 is a flowchart for describing a method of providing advertising corresponding to the construction of a learning path in a learning system according to an embodiment of the present invention.

Referring to FIG. 5, the service provision apparatus 100 constructs a learning path between learning objectives (S301), and outputs previously registered advertising information to a first section to an N-th section in the learning path through the advertising information management unit 180 (S303).

Furthermore, the advertising information management unit 180 may compute use frequency information corresponding to the learning path (S305), and calculates advertising expenses based on the use frequency information and association with learning contents (S307). Accordingly, proper advertising cost pricing and execution can be provided.

For example, the advertising information management unit 180 may compute use frequency of each of users in each of the first section to N-th section in a given learning path in an advertising cost pricing process, and may arrange an advertising posting cost for each of billboards corresponding to learning paths for each section.

Furthermore, in advertising posting for a given learning path, the advertising information management unit 180 may perform processing so that an advertisement is limited to only an advertisement associated with learning contents for the given learning path.

In this case, in order to determine whether the advertisement is an advertisement associated with the learning contents for the given learning path, the advertising information management unit 180 may confirm whether a keyword associated (or matched) with the learning contents in the learning path is included in advertisement source information.

Meanwhile, when providing an advertisement, the advertising information management unit 180 may output the advertising information in accordance with a learning region unit in the aforementioned visual knowledge map in addition to each of the sections in the learning path, and may calculate advertising expenses corresponding to each of the pieces of advertising information.

For example, an advertisement unit having, as a basic unit, a learning item corresponding to a finite area in the visual knowledge map may be determined. The advertising information management unit 180 may process advertising information output and cost calculation corresponding to the advertisement unit.

In this case, if a plurality of learning paths passes through a given learning region in the visual knowledge map, the advertising information management unit 180 may arrange an advertising posting cost in a corresponding region based on a total sum of pieces of use frequency of the learning paths, for example.

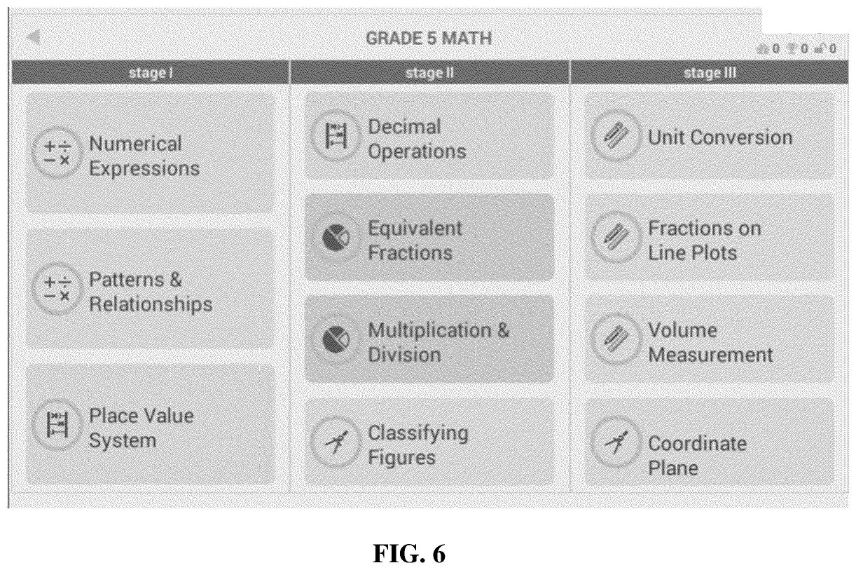

FIGS. 6 to 8 are diagrams for describing graphic interfaces for a learning service according to embodiments of the present invention.

Referring to FIG. 6, a learning objective selection interface for selecting a learning path based on a learning objective according to an embodiment of the present invention may be displayed on the terminal 200. A learner may enter the learning path by selecting any one of a plurality of learning objectives.

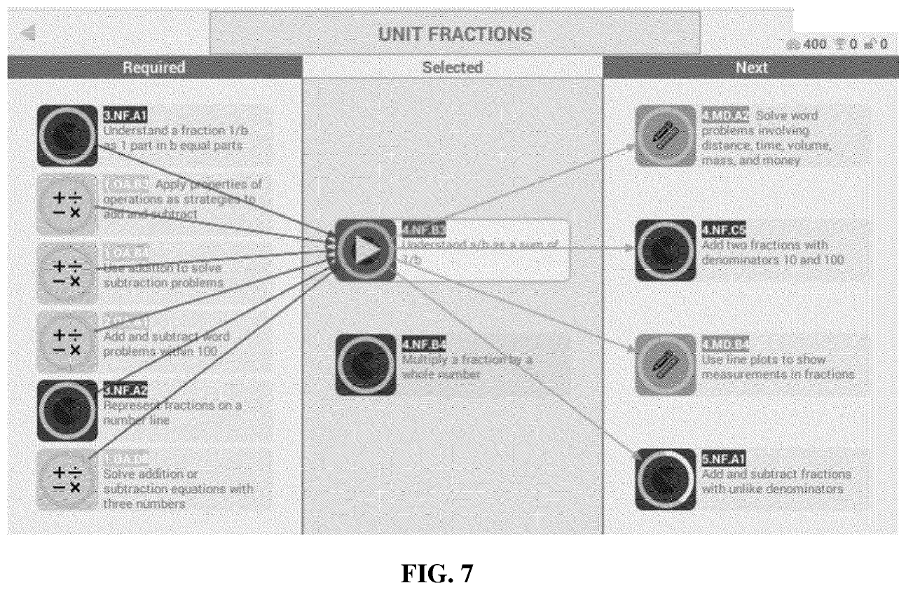

FIG. 7 is a diagram illustrating a learning path interface that appears when a specific learning objective is selected. As illustrated in FIG. 7, in order to understand a learning objective 4.NF.B3, it is necessary to complete the learning of all 3.NF.A1, 1.0A.B3, 1.OA.B4, . . . , that is, precedence learning items. In contrast, for a follow-up learning item such as 4.NF.C5, it is necessary to complete the current 4.NF.B3.

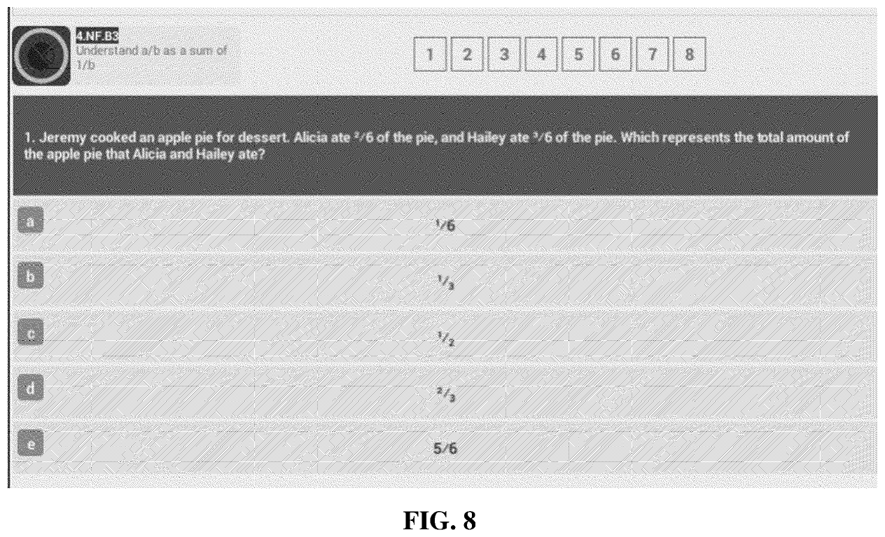

As illustrated in FIG. 8, a problem solving service needs to be used in order to complete objectives in a learning path based on each learning objective. From FIG. 8, it may be seen that eight problems for completing 4.NF.B3 are set. Accordingly, precedence learning based on a percentage of correct answers or wrong-answered question, such as that described with reference to FIG. 3 or 4, can be processed stage by stage and repeatedly. Accordingly, a learner's learning ability can be significantly improved.

The method according to the present invention may be fabricated as a program for being executed in a computer and may be stored in a computer-readable recording medium. Examples of the computer-readable recording medium include a ROM, a RAM, a CD-ROM, a magnetic tape, a floppy disk, and an optical data storage device.

The computer-readable recording medium may be distributed to computer systems connected over a network so that computer-readable code can be stored and executed in a distributed manner. Furthermore, functional programs, codes, and code segments for implementing the above method may be easily inferred by programmers of the technical field to which the present invention belongs.

Furthermore, while the present invention has been particularly shown and described with reference to exemplary embodiments thereof, it is to be understood that the present invention is not limited to the disclosed exemplary embodiments, but, on the contrary, It will be understood by those skilled in the art that various changes and modifications may be made without departing from the spirit and scope of the present invention.

1. A method of providing a learning service, comprising steps of:
constructing learning path information connecting one or more learning objectives;
providing a problem solving service corresponding to a first learning objective of the learning path to a terminal of a learner; and
determining whether to provide learning content corresponding to the first learning objective based on a result of problem solving of the learner.

2. The method of claim 1, further comprising a step of providing learning content corresponding to the first learning objective when a percentage of correct answers based on the result of the problem solving is a first reference or more.

3. The method of claim 2, further comprising steps of:
selecting a precedence learning objective determined based on the learning path in accordance with the first learning objective when the percentage of correct answers based on the result of the problem solving is less than the first reference; and
providing learning content corresponding to the precedence learning objective when a percentage of correct answers of a problem solving service corresponding to the precedence learning objective is less than a second reference.

4. The method of claim 3, further comprising a step of providing the learning content corresponding to the first learning objective when the percentage of correct answers of the problem solving service corresponding to the precedence learning objective is the second reference or more.

5. The method of claim 1, further comprising a step of providing learning content corresponding to a wrong-answered question based on the result of the problem solving when the wrong-answered question occurs.

6. The method of claim 5, further comprising steps of:
selecting the precedence learning objective of the learning path based on the occurred wrong-answered question when a number of the wrong-answered question occurred based on the result of the problem solving is a specific number or more; and
providing learning content corresponding to the precedence learning objective when a percentage of correct answers of a problem solving service corresponding to the precedence learning objective is less than a given reference.

7. The method of claim 6, further comprising a step of providing learning content corresponding to contents of the wrong-answered question when the percentage of correct answers of the problem solving service corresponding to the precedence learning objective is the given reference or more.

8. The method of claim 1, wherein the constructing step further comprises a step of configuring advertising information in each of sections of the learning path.

9. The method of claim 8, wherein:
the providing step further comprises a step of providing the terminal of the learner with advertising information based on the configuration of the advertising information, and
the providing step further comprises steps of:
computing use frequency in each section corresponding to the learning path; and
calculating cost information corresponding to the provision of the advertising information based on the use frequency.

10. The method of claim 9, wherein the step of calculating cost information comprises steps of:
computing association between learning information for each section and the advertising information corresponding to the learning path; and
calculating the cost information using the use frequency and the association.

11. An apparatus for providing a learning service, comprising:
a learning information management unit constructs learning path information connecting one or more learning objectives;
a problem information management unit provides a problem solving service corresponding to a first learning objective of the learning path to a terminal of a learner; and
a service provision unit determines whether to provide learning content corresponding to the first learning objective based on a result of problem solving of the learner.

12. The apparatus of claim 11, wherein the service provision unit provides learning content corresponding to the first learning objective when a percentage of correct answers based on the result of the problem solving is a first reference or more.

13. The apparatus of claim 12, wherein:
the problem information management unit selects a precedence learning objective determined based on the learning path in accordance with the first learning objective when the percentage of correct answers based on the result of the problem solving is less than the first reference, and
the service provision unit provides a problem solving service corresponding to the precedence learning objective and provides learning content corresponding to the precedence learning objective when a percentage of correct answers of the problem solving service is less than a second reference.

14. The apparatus of claim 12, wherein the service provision unit provides learning content corresponding to a wrong-answered question based on the result of the problem solving when the wrong-answered question occurs.

15. The apparatus of claim 14, wherein:
the problem information management unit selects the precedence learning objective of the learning path based on the occurred wrong-answered question when a number of the wrong-answered question occurred based on the result of the problem solving is a specific number or more, and
the service provision unit provides a problem solving service corresponding to the precedence learning objective and provides learning content corresponding to the precedence learning objective when a percentage of correct answers of the problem solving service is less than a given reference.

16. The apparatus of claim 11, further comprising an advertising information management unit configuring advertising information in each of sections of the learning path.

17. The apparatus of claim 16, wherein the advertising information management unit provides the terminal of the learner with advertising information based on the configuration of the advertising information, computes use frequency in each section corresponding to the learning path, and calculates cost information corresponding to the provision of the advertising information based on the use frequency.

18. The apparatus of claim 17, wherein the advertising information management unit computes association between learning information for each section and the advertising information corresponding to the learning path and calculates the cost information using the use frequency and the association.

19. The apparatus of claim 17, wherein the advertising information management unit performs processing so that an advertisement is limited to only an advertisement associated with learning contents for a given learning path.

20. The apparatus of claim 19, wherein the advertising information management unit confirms whether a keyword matched with learning contents in the learning path is included in advertisement source information in order to determine whether the advertisement is an advertisement associated with the learning contents for the given learning path.

21. The apparatus of claim 11, further comprising an advertising information management unit configuring advertising information in accordance with a learning region unit in a visual knowledge map through which the learning path passes.

22. The apparatus of claim 21, wherein:
the learning region unit includes, as a basic unit, a learning item corresponding to a finite area in the visual knowledge map, and
an advertisement unit by which advertising information output and cost calculation are processed is determined based on the basic unit.

23. The apparatus of claim 22, wherein the advertising information management unit arranges an advertising posting cost of the advertisement unit based on a total sum of pieces of use frequency of respective learning paths if a plurality of the learning paths passes through the learning region unit in the visual knowledge map.

24. The apparatus of claim 11, wherein:
the terminal of the learner is plural in number,
the first learning objective is designated by a learning leader terminal corresponding to the plurality of terminals of the learners, and
the service provision unit provides homework information corresponding to the first learning objective based on the result of the problem solving of the learner so that homework information of each learner based on a result of the problem solving is individually provided to the terminal of each of the learners.
